(19) United States
(12) Patent Application Publication
(10) Pub. No.: US 2013/0023809 A1
(43) Pub. Date: Jan. 24, 2013

(54) Peripheral Pain-Relief Device that is Non-Invasive and Non-Pharmaceutical

(71) Applicant: John Virgil Spence, Vidalia, GA (US)

(72) Inventor: John Virgil Spence, Vidalia, GA (US)

(21) Appl. No.: 13/552,047

(22) Filed: Jul. 18, 2012

Related U.S. Application Data
(60) Provisional application No. 61/508,941, filed on Jul. 18, 2011.

(51) Int. Cl. A61H 9/00

(52) U.S. Cl. 601/154

(57) ABSTRACT

A non-invasive peripheral pain relief device provides pain relief from skin injury such as burns, avulsions, lacerations and scrapes without the use of pharmaceuticals or invasive treatments. The device uses the body's own physiology, specifically lateral inhibition, to give both temporary and sustained relief of pain. This process uses the body's own neurotransmitter mechanisms to control pain without pharmaceuticals or invasive treatments. Varying, extremely light, bursts of air are applied sequentially to the periwound to affect relief centrally.

### CROSS-REFERENCES TO RELATED APPLICATIONS

This application claims the benefit of U.S. Provisional Patent Application Ser. No. 61/508,941, filed Jul. 18, 2011, the entire content of which is herein incorporated by reference.

### STATEMENT REGARDING FEDERALLY SPONSORED RESEARCH OR DEVELOPMENT

(NOT APPLICABLE)

### BACKGROUND OF THE INVENTION

The present invention relates to a pain relief device that is non-invasive and does not use pharmaceuticals.

Currently, this problem is treated with prescription narcotic pain relief medications and over the counter pain relief medications that often have to be given for long periods of time. These drugs and medications are expensive and make patients susceptible to both dependence and tolerance.

### BRIEF SUMMARY OF THE INVENTION

The invention is designed to lay over intact skin to deliver sequential microbursts of air streams to periwound skin and elicit the body's own neuroinhibitory response at surrounding sensory neurons. Specifically, those that are within the wound bed of the injured area.

There is currently no similar device available.

### BRIEF DESCRIPTION OF THE DRAWINGS

These and other aspects and advantages will be described in detail with reference to the accompanying drawings, in which:

FIG. 1 is a perspective view of the invention shown in use;

FIG. 2 is a front view of the pump enclosure;

FIG. 3 is a top view of the flexible delivery device;

FIG. 4 is a section view of the flexible delivery device taken along line 4-4 in FIG. 1;

FIG. 5 is a perspective view of an alternate embodiment of the invention; and

FIG. 6 is a section view of an alternate embodiment of the invention taken along line 6-6 in FIG. 5.

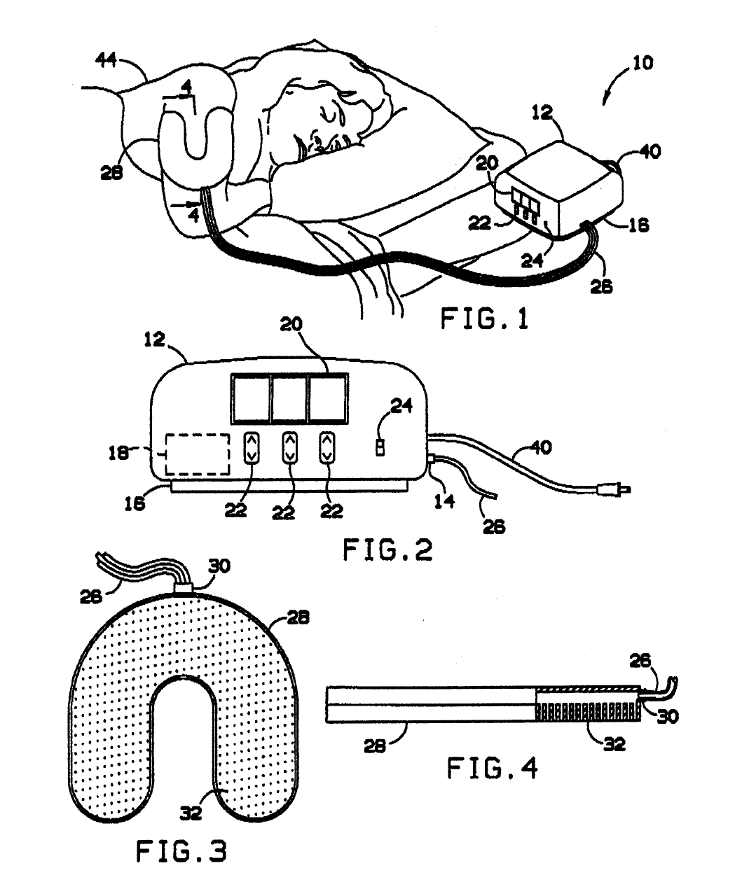

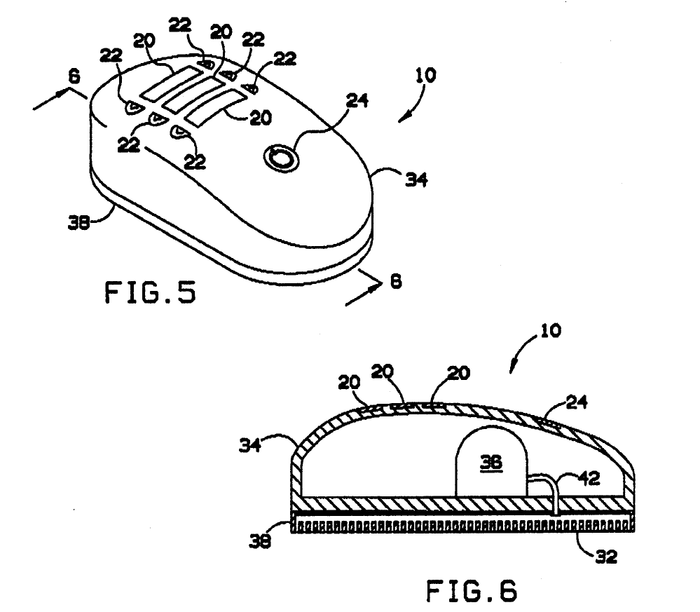

### DETAILED DESCRIPTION OF THE INVENTION

The reference numerals in the drawings correspond to the following components of the invention:

10 is the overall invention.

12 is the pump enclosure.

14 is the pump enclosure hose fitting.

16 is the pump enclosure base.

18 is the air pump.

20 are the digital pressure displays.

22 are the pressure adjustment touch pads.

24 is the on/off switch.

26 is the three vessel hose.

28 is the flexible delivery device.

30 is the delivery device hose fitting.

32 are the delivery device micro perforations.

34 is the self contained pain relief device.

36 is the small air pump.

38 is the disposable flexible delivery device.

40 is the pump enclosure power cord.

42 is the small three vessel hose.

44 is the person.

Exemplary embodiments are shown in the drawings:

(1) Could be a small encased air pump with an adjustable or fixed pressure manifold that delivers variable strengths of microburst of air through one hose or a series of hoses into the chamber or chambers of a soft plastic or other elastomeric material delivery device that will be flexible as to conform to body shapes and sizes. The contact surfaces can have various sub-millimeter or same size holes through which various strength bursts of air (regulated by the air pressure and manifold) will pass from the pump or air supply unit to lightly stimulate sensory receptors in the skin at the periphery of wounds. These will, in-turn, suppress the surrounding painful stimuli.

(2) This form will be a self-contained hand held unit, approximately the size of a computer mouse, that will have a small air pump and manifold and on the bottom will have a disposable cover with the same sub-millimeter pores for various strength bursts and pressures (as described in embodiment 1) of air that pass directly onto the skin to elicit the desired response.

(3) This form can receive its air supply from a portable air tank, stationary air tank or any other type of air supply that is both convenient and available. Embodiment (3) will eliminate the need of the hand held or stationary air compressor and rely on an independent manifold that will deliver the air burst to the device through the various air supply tubes.

The air pump will be housed in a small case that may be held or positioned on a table etc. A series of hoses can connect the air pump to the delivery device that will be flexible, to conform to body surfaces, and come in various sizes and shapes depending on the size of the wound or treatment area.

The delivery devices are designed to be modular and by use of two or more devices that can be arranged to conform to any shape wound and deliver air burst evenly around the entire perimeter of a wound.

The pump and manifold base will send various strength pulses of air through the hoses to the delivery device that will have sub-millimeter pores, of same size or various sizes, through which the variable bursts of air pressures will pass and contact the patient's skin.

An air pump would be designed and placed in a hard plastic case. Fittings, attached to the case, would interface air from the pump and the hoses. Hoses would be attached to the base, described above, to deliver the air to the delivery device which would be made via plastic/silicone molding or any other type of flexible hoses or piping but not limited to.

The delivery device can be unplugged from the delivery hoses or manifold so that the same pump or air supply can be used on several patients or to simply change to a larger, smaller or different shaped delivery device for the same patient.

When a patient has a painful skin, epidermis or dermis problem from trauma or any other cause, the delivery device will be place at the edge of the site of injury/problem on the good/normal skin that is as close as possible to the site of concern. The pump or air supply will be turned on, travel through the manifold and the microburst of air will lightly stimulate the surrounding healthy skin. It will be such a light stimulation that the sensory neurons within the skin with the device over it will begin to suppress sensory stimuli from surrounding sensory neurons that are in the problem/painful area via the normal neurologic mechanism of lateral inhibition.

The device of the described embodiments delivers pulsating bursts of air in various pressures and varying pulses to the peripheral areas around a wound. The delivery system is through a pad or device that has holes that become the outlet for the pulsating burst of air. This pad or device can have compressed air delivered to it in various ways and method i.e.; mechanical compressors, air tanks, etc.

Regardless of the air supply device a miti-port monitoring manifold device can be used to deliver the varying air burst. The air burst is delivered from the manifold to the device pad via three color coded hoses that are the same color as the control knob on the manifold.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A peripheral pain-relief device that is non-invasive and non-pharmaceutical.

2-5. (canceled)
